(19) United States
(12) Patent Application Publication
(10) Pub. No.: US 2011/0117846 A1
(43) Pub. Date: May 19, 2011

(54) METHOD FOR USING vNote IN PORTABLE TERMINAL

(75) Inventors: Kyong-Hun LEE, Cheongwon-gun (KR); Min-Jee KANG, Gumi-si (KR)

(73) Assignee: SAMSUNG ELECTRONICS CO. LTD., Suwon-si (KR)

(21) Appl. No.: 12/946,108

(22) Filed: Nov. 15, 2010

(30) Foreign Application Priority Data
Nov. 13, 2009 (KR) 10-2009-0109756

(51) Int. Cl. H04B 7/00

(52) U.S. Cl. 455/41.2

(57) ABSTRACT

A method for using vNote in a portable terminal is provided. The method includes requesting transmission of a vNote message, inserting a variable for setting the vNote message as a message to be used for a Bluetooth messenger into the vNote message, and transmitting the vNote message into which the variable for setting the vNote message is inserted as a message to be used for the Bluetooth messenger.

### PRIORITY

This application claims the benefit under 35 U.S.C. §119(a) of a Korean Patent Application filed in the Korean Intellectual Property Office on Nov. 13, 2009 and assigned Serial No. 10-2009-0109756, the entire disclosure of which is hereby incorporated by reference.

### BACKGROUND OF THE INVENTION

1. Field of the Invention

The present invention generally relates to a portable terminal More particularly, the present invention relates to a method for using vNote in a portable terminal.

2. Description of the Related Art

Recently, Bluetooth has come into wide use. Bluetooth is a wireless Local Area Network (LAN) standard that uses a frequency of 2.45 GHz, which is the same Industrial, Scientific, and Medical (ISM) band as 802.11b/g. Bluetooth devices can perform wireless communication through processes such as search/selection/authentication (pairing) with respect to neighboring Bluetooth devices.

Bluetooth has been rapidly popularized at its 2.0 version, as communication quality of a predetermined level is guaranteed by the addition of an Enhanced Data Rate (EDR) standard thereto. With the popularization of Bluetooth, portable terminals having a Bluetooth function have also come into common use. In particular, short-range data communication using Bluetooth has been popularized. An example is message exchange through vNote transmission/reception using Bluetooth communication.

vNote, specified in Infrared Mobile Communication (IrMC), defines a format of a message or a note. Users of portable terminals can exchange messages through transmission and reception of vNote. Despite free and convenient message exchange through Bluetooth communication, vNote cannot allow a user to simultaneously check a message transmitted by the user and a message received from a partner like in a Short Messaging Service (SMS) message.

In other words, a user of a portable terminal can check a vNote message received from a communication partner in response to a vNote message generated and transmitted by the user, but cannot check both the generated and transmitted vNote message and the received response vNote message at the same time. As a result, in case of vNote message exchange, the user cannot see messages exchanged between the user and the partner at a time (or at the same time) like in real-time chatting.

A Bluetooth messenger is an example of short-range communication using Bluetooth. The Bluetooth messenger transmits and receives vNote messages through a profile such as an Object Push Profile (OPP), and allows a real-time chatting function by displaying vNote messages, transmitted and received through Bluetooth communication, on a display screen of the Bluetooth messenger.

However, vNote cannot recognize whether transmitted and received vNote messages are vNote messages to be used with the Bluetooth messenger or vNote messages not to be used with the Bluetooth messenger. Accordingly, to use a real-time chatting function through vNote transmission and reception using the Bluetooth messenger, a user transmitting a vNote message should first execute the Bluetooth messenger, and then generate and transmit the message, and a user receiving the vNote message can use the real-time chatting function using vNote only if the Bluetooth messenger has been executed.

### SUMMARY OF THE INVENTION

An aspect of the present invention is to address at least the above-mentioned problems and/or disadvantages and to provide at least the advantages described below. Accordingly, an aspect of the present invention is to provide a method for identifying whether a vNote message is a general vNote message for message exchange rather than for a Bluetooth messenger or a vNote message to be used for in the Bluetooth messenger for real-time chatting.

Another aspect of the present invention is to provide a method for providing a real-time chatting function by automatically executing a Bluetooth messenger upon reception of a vNote message even if the Bluetooth messenger has not been executed.

In accordance with an aspect of the present invention, a method for using vNote in a portable terminal is provided. The method includes requesting transmission of a vNote message, inserting a variable for setting the vNote message as a message to be used for a Bluetooth messenger into the vNote message, and transmitting the vNote message into which the variable for setting the vNote message is inserted as a message to be used for the Bluetooth messenger.

In accordance with another aspect of the present invention, a method for using vNote in a portable terminal is provided. The method includes upon receiving a vNote message, determining whether the received vNote message is a vNote message being set to be used for a Bluetooth messenger, if it is determined that the received vNote message is a vNote message being set to be used for the Bluetooth messenger, determining whether the Bluetooth messenger is operating, and if it is determined that the Bluetooth messenger is operating, displaying the vNote message being set to be used for the Bluetooth messenger through the Bluetooth messenger.

In accordance with another aspect of the present invention, a mobile terminal is provided. The mobile terminal includes an input unit for receiving input from which a vNote message is generated, a Bluetooth module for performing Bluetooth communication, and a control module for controlling execution of a Bluetooth messenger included in the Bluetooth module, for inserting a predetermined variable into the generated vNote message indicating whether the Bluetooth messenger is to be used to display the generated vNote message, and for transmitting the generated vNote message to a destination device via the Bluetooth module.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiment of the present invention will be more apparent from the following description taken in conjunction with the accompanying drawings, in which:

FIG. 1 is a block diagram of a portable terminal according to an exemplary embodiment of the present invention;

FIG. 2 is a flowchart illustrating a process of generating and transmitting a vNote message according to an exemplary embodiment of the present invention;

FIG. 3 is a flowchart illustrating a process of receiving and displaying a vNote message according to an exemplary embodiment of the present invention; and

FIGS. 4A through 4D are exemplary diagrams for describing a process of receiving and displaying a vNote message according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to an exemplary embodiment of the present invention, a Bluetooth messenger refers to a messenger for providing a real-time chatting function by means of Bluetooth communication by transmitting and receiving a vNote message through an Object Push Profile (OPP).

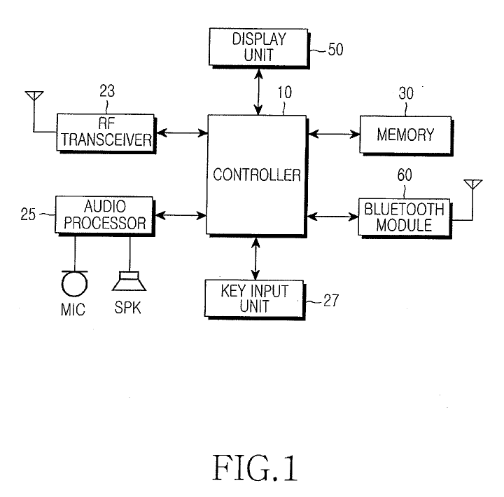

FIG. 1 is a block diagram of a portable terminal according to an exemplary embodiment of the present invention.

Referring to FIG. 1, a key input unit 27 includes keys for numbers and character information and functional keys for setting various functions. A user can generate a vNote message via the key input unit 27.

A Radio Frequency (RF) transceiver 23 for performing a wireless communication function of the portable terminal includes an RF unit and a modem. The RF unit includes an RF transmitter for up-converting a frequency of a transmission signal and amplifying the up-converted transmission signal and an RF receiver for low-noise-amplifying a received signal and down-converting a frequency of the low-noise-amplified signal. The modem includes a transmitter for encoding and modulating the transmission signal and a receiver for demodulating and decoding the received signal.

An audio processor 25 may constitute a codec including a data codec and an audio codec. The data codec processes packet data and the audio codec processes audio signals like voice and a multimedia file. The audio processor 25 also converts a digital audio signal received from the modem into an analog audio signal through the audio codec and reproduces the analog audio signal, or converts an analog audio signal generated from a microphone (MIC) into a digital audio signal through the audio codec and transmits the digital audio signal to the modem. The codec may be separately provided or may be included in a controller 10 of the portable terminal. Upon completion of generation of a vNote message or completion of transmission or reception of the vNote message, the audio processor 25 may inform a user of the completion by using audio information. The audio processor 25 transmits the audio signal to the user via the speaker (SPK).

A memory 30 includes a Read Only Memory (ROM) and a Random Access Memory (RAM). The memory 30 may include program memories and data memories and store programs for controlling an operation of the portable terminal and data for booting.

A display unit 50 displays an image signal and user data on a screen or displays data associated with communication. The display unit 50 may include a Liquid Crystal Display (LCD), Organic Light Emitting Diodes (OLED), or Active Matrix Organic Light Emitting Diodes (AMOLED). When the LCD, OLED, or AMOLED is implemented with a touch screen, the display unit 50 may operate as an input unit for controlling the portable terminal, together with the key input unit 27. Thus, the display unit 50 may serve as an input unit for controlling the portable terminal, together with the key input unit 27, by including a touch screen.

A Bluetooth module 60 performs Bluetooth communication with another Bluetooth device (for example, a portable terminal such as a mobile communication terminal, an MP3 player, a PC, or a PDA) through a Bluetooth antenna according to a Bluetooth protocol. In the Bluetooth module 60 are stored a host stack for managing Bluetooth communication, a Bluetooth profile selected according to functions or conditions of external Bluetooth devices targeted for communication, and application programs. The Bluetooth profile includes various profiles, such as a HandsFree Profile (HFP) for supporting handsfree sets, a HeadSet Profile (HSP) for supporting headsets, an Advanced Audio Distribution Profile (A2DP) for supporting stereo audio, or an Audio/Video Remote Control Profile (AVRCP). Of these profiles, a profile corresponding to a connected Bluetooth device is used. The Bluetooth module 60 includes an OPP and provides a Bluetooth messenger function through the included OPP. The Bluetooth module 60 according to an exemplary embodiment of the present invention may be included in the RF transceiver 23.

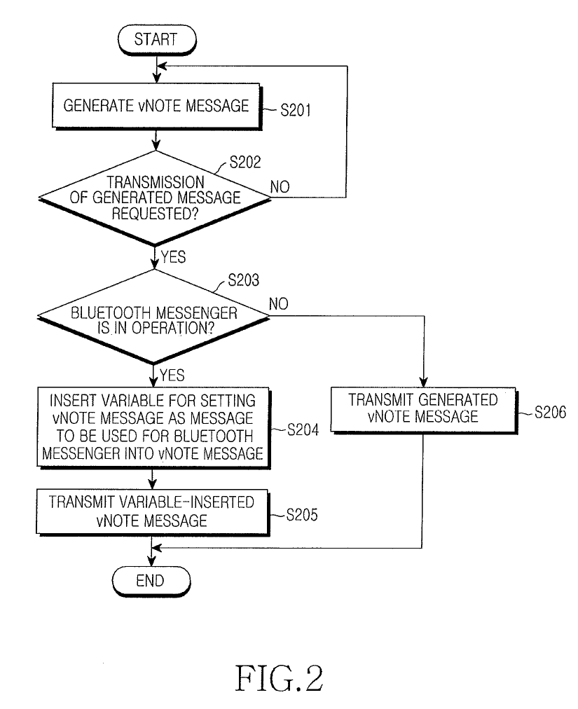

The controller 10 controls the overall operation of the portable terminal. The controller 10 transmits a vNote message after inserting a predetermined variable to the vNote message. If a Bluetooth messenger is not executed at the time of reception of the vNote message, the controller 10 controls the Bluetooth messenger to be automatically executed and display the received vNote message. More detailed operations of the controller 10 according to an exemplary embodiment of the present invention will be described below with reference to FIGS. 2 through 4.

FIG. 2 is a flowchart illustrating a process of generating and transmitting a vNote message according to an exemplary embodiment of the present invention.

Referring to FIG. 2, once a user generates a vNote message in step S201 and requests transmission of the generated vNote message in step S202, the controller 10 determines whether a Bluetooth messenger is in operation in step S203. If no vNote message is being transmitted, operations return to step S201.

If it is determined that the Bluetooth messenger is in operation in step S203, the controller 10 performs a control operation in step S204 such that a variable for setting the transmission-requested vNote message as a message to be used for the Bluetooth messenger is inserted into the transmission-requested vNote message.

The controller 10 inserts a variable name BTM_TYPE and a variable value btm_support or btm_notsupport into the structure of the vNote message as shown in the following example. The variable value btm_support sets the vNote message as a message to be used for the Bluetooth messenger, and the variable value btm_notsupport sets the vNote message as a message not to be used for the Bluetooth messenger.

Consequently, the controller 10 inserts the variable value btm_support into the transmission-requested vNote message in step S204, thereby setting the transmission-requested vNote message as a message to be used for the Bluetooth messenger.

[Example of Variable Insertion]

```
    typedef struct
    {
        VITEM_VEVENT_TYPE type;
        CHAR
dcreated[VNOTE_MAX_DATETIME_SIZE+1];
        CHAR
Last_Modified[VNOTE_MAX_DATETIME_SIZE+1];
        CHAR
summary[VNOTE_MAX_SUMMARY_SIZE*3+1];
```

| | |
|---|---|
| vNote_body_t | body; |
| CLASS_TYPE | private_class; |
| BTM_TYPE | btm_support; /* Added variable for BTM |

```
*/
    } vitem_vnote_t;
    typedef enum
    {
        B_SUPPORT,
        B_NOTSUPPORT,
        MAX_BTM_TYPE
    } BTM_TYPE;
```

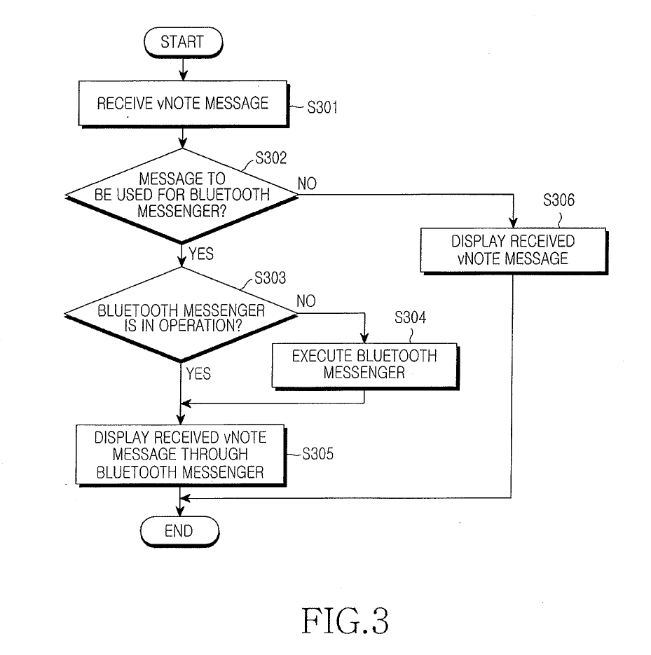

While FIG. 2 illustrates an exemplary method in which a variable is inserted when there is a request for transmission and the Bluetooth messenger is operating, the variable may also be inserted into the vNote message by providing a separate menu even when the Bluetooth messenger is not operating. In this case, by checking the variable inserted into the vNote message, for example, btm_support, the Bluetooth messenger may be automatically executed in a portable terminal having received the variable-inserted vNote message, as will be described later with reference to FIG. 3. Upon completion of the insertion of the variable in step S204, the controller 10 transmits the variable-inserted vNote message in step S205.

Unlike in steps S203 through S205, if it is determined in step S203 that the Bluetooth messenger is not operating, the controller 10 transmits the vNote message in step S206, without inserting the variable into the vNote message.

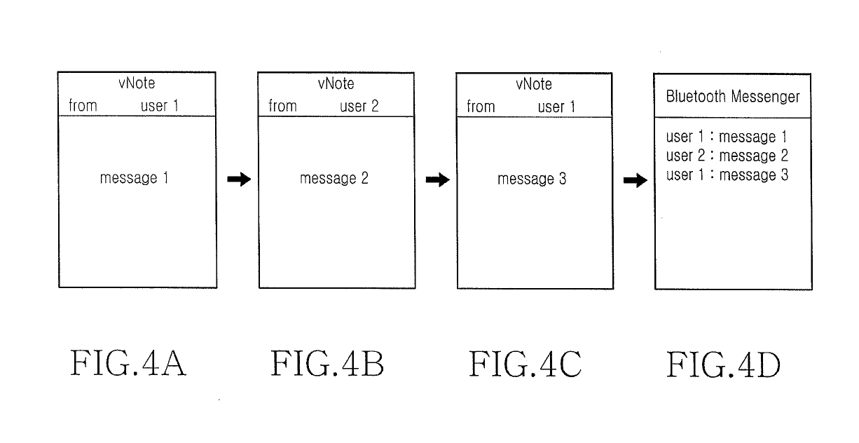

FIG. 3 is a flowchart illustrating a process of receiving and displaying a vNote message according to an exemplary embodiment of the present invention, and FIGS. 4A through 4D are exemplary diagrams for describing a process of receiving and displaying a vNote message according to an exemplary embodiment of the present invention.

FIGS. 4A through 4C illustrate examples where a received vNote message is not displayed through the Bluetooth messenger. The time sequential order related to the reception of the vNote message is FIG. 4A->FIG. 4B->FIG. 4C.

Referring to FIGS. 4A-4C, FIG. 4A illustrates an example where a portable terminal of a user 1 generates a message 1 in the format of a vNote message and transmits the message 1 to a portable terminal of a user 2. The portable terminal of the user 2 displays the vNote message (including contents of the message 1) received from the portable terminal of the user 1 as shown in FIG. 4A.

FIG. 4B illustrates an example where the portable terminal of the user 2 generates a message 2 in the format of a vNote message and transmits the message 2 to the portable terminal of the user 1. The portable terminal of the user 1 displays the vNote message (including contents of the message 2) received from the portable terminal of the user 2 as shown in FIG. 4B.

FIG. 4C illustrates an example where the portable terminal of the user 1 generates a message 3 in the format of a vNote message and transmits the message 3 to the portable terminal of the user 2. The portable terminal of the user 2 displays the vNote message (including contents of the message 3) received from the portable terminal of the user 1 as shown in FIG. 4C.

Referring to FIGS. 4A through 4C, if the received vNote message is displayed without using the Bluetooth messenger, the vNote message is quite similar to a general Short Message Service (SMS) message. As a result, a user cannot check a message transmitted from the user to a communication partner, and can check only a message received from the communication partner.

Referring to FIG. 4D, an example is illustrated where the portable terminal of the user 1 and the portable terminal of the user 2 display vNote messages transmitted and received therebetween (for example, vNote messages into which the variable value btm_support is inserted) through the Bluetooth messenger. When the transmitted and received vNote messages are displayed as shown in FIG. 4D, the users (for example, the user 1 and the user 2) can check both the message generated by the users and the message received from the communication partners, thereby enjoying a real-time chatting function.

Referring to FIG. 3, upon reception of a vNote message through Bluetooth communication in step S301, the controller 10 determines in step S302 whether the received vNote message is a message to be used with the Bluetooth messenger.

The controller 10 checks a structure of the received vNote message to determine whether a variable value of a variable name (for example, BTM_TYPE) is btm_support or btm_notsupport. As described above with reference to FIG. 2, if the variable value is btm_support, the received vNote message is a message being set to be used for the Bluetooth messenger; whereas if the variable value is btm_notsupport, the received vNote message is a message being set not to be used for the Bluetooth messenger.

If it is determined in step S302 that the received vNote message is a message to be used with the Bluetooth messenger, the controller 10 determines whether the Bluetooth messenger is in operation in step S303.

If it is determined in step S303 that the Bluetooth messenger is not in operation, the controller 10 goes to step S305 after executing the Bluetooth messenger in step S304. If it is determined in step S303 that the Bluetooth messenger is in operation, the controller 10 goes to step S305 to display the received vNote message through the Bluetooth messenger.

Without using the Bluetooth messenger, only a vNote message received from a communication partner can be displayed as shown in FIGS. 4A through 4C. On the other hand, vNote messages can be displayed through the Bluetooth messenger as shown in FIG. 4D through steps S302 through S305. Therefore, each user (e.g., the user 1 and the user 2) can check a message transmitted from the user and a message received from the communication partner at the same time.

After the received vNote message is displayed through the executed Bluetooth messenger, the user may generate a response message with respect to the received vNote message through the executed Bluetooth messenger. For example, when receiving the vNote message including the contents of the message 1 from the user 1, the user 2 may input the contents of the message 2 through an input window (not shown) of the Bluetooth messenger and transmit the message 2 through the Bluetooth messenger, and may check a response message (for example, the message 3) received from the user 1 with respect to the message 2 as shown in FIG. 4D.

If it is determined in step S302 that the received vNote message is a message not to be used with the Bluetooth messenger, the controller 10 displays the received vNote message in step S306. The vNote message displayed in step S306 is not displayed through the Bluetooth messenger as shown in FIGS. 4A through 4C, whereby only the message received from the partner is displayed.

As can be appreciated from the foregoing description, exemplary embodiments of the present invention can provide the real-chatting function through vNote messages. Moreover, according to exemplary embodiments of the present invention, upon reception of the vNote message, the Bluetooth messenger is automatically executed, thereby allowing a user to promptly and conveniently use the Bluetooth messenger without manipulating a key for executing the Bluetooth messenger.

While the invention has been shown and described with reference to certain exemplary embodiments thereof, it will be understood by those skilled in the art that various changes in form and details may be made therein without departing from the spirit and scope of the invention as defined by the accompanying claims and their equivalents.

What is claimed is:

1. A method for using vNote in a portable terminal, the method comprising:
requesting transmission of a vNote message;
inserting a variable for setting the vNote message as a message to be used for a Bluetooth messenger into the vNote message; and
transmitting the vNote message into which the variable for setting the vNote message is inserted as a message to be used for the Bluetooth messenger.

2. The method of claim 1, wherein a variable value of the variable for setting the vNote message as a message to be used for the Bluetooth messenger is btm_support.

3. The method of claim 1, further comprising:
inserting a variable for setting the vNote message as a message not to be used for the Bluetooth messenger into the transmission-requested vNote message.

4. The method of claim 3, wherein a variable value of the variable for setting the vNote message as a message not to be used for the Bluetooth messenger is btm_notsupport.

5. A method for using vNote in a portable terminal, the method comprising:
upon receiving a vNote message, determining whether the received vNote message is a vNote message being set to be used for a Bluetooth messenger;
if it is determined that the received vNote message is a vNote message being set to be used for the Bluetooth messenger, determining whether the Bluetooth messenger is operating; and
if it is determined that the Bluetooth messenger is operating, displaying the vNote message being set to be used for the Bluetooth messenger through the Bluetooth messenger.

6. The method of claim 5, further comprising:
if it is determined that the Bluetooth messenger is not operating, executing the Bluetooth messenger; and
displaying the vNote message being set to be used for the Bluetooth messenger through the executed Bluetooth messenger.

7. The method of claim 5, wherein the vNote message being set to be used for the Bluetooth messenger has a variable value of btm_support inserted therein.

8. The method of claim 6, wherein the vNote message being set to be used for the Bluetooth messenger has a variable value of btm_support inserted therein.

9. A mobile terminal, comprising:
an input unit for receiving input from which a vNote message is generated;
a Bluetooth module for performing Bluetooth communication; and
a control module for controlling execution of a Bluetooth messenger included in the Bluetooth module, for inserting a predetermined variable into the generated vNote message indicating whether the Bluetooth messenger is to be used to display the generated vNote message, and for transmitting the generated vNote message to a destination device via the Bluetooth module.

10. The mobile terminal of claim 9, wherein when the Bluetooth module receives a vNote message, the control module determines whether the received vNote message is to be used for the Bluetooth messenger based on whether the received vNote message includes the predetermined variable.

11. The mobile terminal of claim 10, wherein, when the received vNote message does not include the predetermined variable, the control module controls the mobile terminal to display the received vNote message without using the Bluetooth messenger.

12. The mobile terminal of claim 11, wherein, when the received vNote message includes a variable indicating that the received vNote message is not to be displayed via the Bluetooth messenger, the control module controls the mobile terminal to display the received vNote message without using the Bluetooth messenger.

13. The mobile terminal of claim 10, wherein, when the received vNote message includes the predetermined variable, the control module controls the mobile terminal to display the received vNote message via the Bluetooth messenger.

14. The mobile terminal of claim 10, wherein the control messenger controls the mobile terminal to execute the Bluetooth messenger when the received vNote message contains the predetermined variable and the Bluetooth messenger is not executing.

15. The mobile terminal of claim 9, wherein the control module inserts the predetermined variable into the generated vNote message when the Bluetooth messenger is executing.

16. The mobile terminal of claim 9, wherein when the Bluetooth messenger is not to be used for the generated vNote message, the control module inserts a variable into the generated vNote message indicating that the Bluetooth messenger is not to be used.
